(19) United States
(12) Patent Application Publication
(10) Pub. No.: US 2007/0089174 A1
(43) Pub. Date: Apr. 19, 2007

(54) Content management system and method for DRM enforcement in a client-server system

(75) Inventors: David M. Bader, Erwinna, PA (US); John D. Charbonneau, Kula, HI (US); Harry T. Horner, Hellertown, PA (US); John E. Rylander, Rochester, MN (US)

Correspondence Address: ARTHUR FREILICH, 9045 CORBIN AVE, #260, NORTHRIDGE, CA, 91324-3343, US

(73) Assignee: David M. Bader

(21) Appl. No.: 11/580,380

(22) Filed: Oct. 13, 2006

Related U.S. Application Data
(60) Provisional application No. 60/726,547, filed on Oct. 14, 2005.

(51) Int. Cl. G06F 17/30

(52) U.S. Cl. 726/32

(57) ABSTRACT

A system and method for protecting the rights and DRM technology of a content owner while increasing the convenience for users in a networked environment, e.g., a home network. By redirecting relevant DRM installation requests (e.g., for protected music, video, books, software, etc.) from a user's client device to his home server, and then acting upon authenticated client requests for the installed content strictly via the server, the user gains the convenience of limited client independence while the content owners retain assurance that their content will not be illicitly used by or redistributed to unauthorized users.

### RELATED APPLICATION

This application claims the benefit of U.S. provisional application 60/726,547 filed 14 Oct. 2005.

### FIELD OF THE INVENTION

This invention relates to a system and method for managing protected content in a network system including at least one server and a plurality of client devices.

### BACKGROUND OF THE INVENTION

The Internet enables the legal distribution of various forms of digital content but also makes illegal distribution of such content quite possible. “Digital rights management” (DRM) refers to a set of evolving technologies which share the goal of protecting content owners from electronic violations of their rights. DRM technology is intended to impose restrictions on the uses of digital content which match the restrictions required by a content owner and agreed to by a licensed user. One common approach is to encrypt the digital content using some variety of a “system fingerprint” as part of an encryption key. If the DRM-protected content is moved to or accessed from another computer—even if the license information (whether stored separately as a file or registry entries, or embedded in the content) is moved along with it—the file is generally not decryptable and so is unusable.

There are numerous variations on this DRM theme which can, for example, limit the quantity of systems that are granted such licenses, adding further restrictions such as limiting playback quantity, abbreviation, or quality or limiting the chronological duration of the content's availability.

Such use restrictions are very reassuring for content owners, but are generally quite inconvenient for users. A user's fair use of the protected content is, as a mutually unwanted byproduct, often technologically restricted in unintended ways which seriously inhibit users without benefiting content owners.

For example, the following dysfunctional scenario is common: a user purchases and downloads a media file (e.g. a song) from a legitimate reseller on the Web onto a computer at home. This song is thoroughly protected by DRM technology, and so the song is not merely downloaded to that computer, but locked to that computer. It either cannot be played on another computer or even if it can, such playback will decrement the count of available allowed playback devices. If (as is common) the original quantity of allowed playback devices is two (one for the downloading computer, and one for a portable player), then the entire license is consumed even before the user has put the content on a portable device. Such simplistic rigidity protects the music from illegal redistribution via technical means but, unfortunately, also is likely to inhibit a purchase in the first place.

A related inconvenience for users comes when applying DRM technology to a multi-zone home based system which may include multiple client devices and a central content, or media, server. In typical multi-zone systems, if a given media file is protected by DRM, it simply cannot be listened to in any room/zone in the house, not because the license holder finds this rebarbative, but because it is not easy to make it work since the media file is locked to play on a limited number of client devices—possibly just one—and because a proprietary player is generally required to process the DRM technology. As a result, such known multi-zone systems typically avoid the DRM problem by not playing DRM protected items and relying instead on unprotected sources of music such as compact discs (CDs).

### SUMMARY OF THE INVENTION

The present invention relates to a system and method for managing protected content in a client-server system, e.g., a home based client-server system, in a manner which protects the rights of the content owner while optimizing the convenience for the system's users.

A system in accordance with the invention executes software that (a) redirects installations of content, e.g., a DRM protected media file (and any associated license information), from a client device initiating the installation, to a central media server which then stores, manages, and distributes the content around the client-server network, and (b) ensures that a user at any client device on the network can use the installed content. This approach ensures proper enforcement of DRM (or other protection schemes) while allowing legitimate users on the network to use the content, whether that content comprises data or software.

More particularly, a system in accordance with the invention allows a client device to initiate the purchase of a protected media file, but once this is done, the downloading of the protected file is redirected, under software control, to a central media server. The media server then does the checking of the file, the checking for a license, the acquisition, validation, and storage of the license information, etc. The media server functions to manage all of the media file downloads sending all purchased media files to the media server and not to the client device. The server is then free to decode the media for digital streaming or analog output to various devices on the network. By design, this operating mode will prevent the creation of unprotected copies of the protected content but will allow a user to play the content on various client devices.

In accordance with further aspects of the invention, user and group profiles can be used to save custom settings and favorites (e.g., play lists) without affecting other users or groups; this also may, as desired, affect the DRM controls: in principle rights may be managed not on the basis of being used by a particular device but instead by a particular user or group (or, as a proxy, a particular user or group account on a computer or network). This is particularly helpful in multi-zone media server systems which currently do not support individual user or group profiles, but simply individual-zone and shared settings.

The DRM enhancements to home based systems described herein facilitate a user purchasing protected content from a greater variety of different content sources. Moreover, because embodiments of the invention do not rely on any brand specific DRM technology, systems in accordance with the invention are able to manage content protected by any known type of DRM.

### BRIEF DESCRIPTION OF THE FIGURES

FIG. 1 is a block diagram schematically illustrating an exemplary home based network in which the present invention can be advantageously used;

FIG. 2 is a block diagram schematically illustrating a preferred software procedure in accordance with the present invention for implementing the purchase and installation of digital content;

FIG. 3 is a block diagram similar to FIG. 2 particularly applicable to purchasing digital content from a “well understood” website;

FIG. 4 is a block diagram similar to FIG. 3 but particularly applicable to purchasing digital content from a “recognized but not well understood” website;

FIG. 5 is a block diagram similar to FIG. 4 but particularly applicable to a manually triggered purchase of digital content;

FIG. 6 is a block diagram schematically illustrating a preferred software procedure for installing protected digital content (e.g., purchased in accordance with FIG. 4) on the system's content server;

FIG. 7 is a block diagram schematically illustrating a preferred software procedure for installing protected digital content (e.g., purchased in accordance with FIG. 5) on the system's content server;

FIG. 8 is a block diagram schematically illustrating a software procedure for redirecting digital content after it has been initially installed;

FIG. 9 is a block diagram schematically illustrating a preferred software procedure for using the installed digital content;

FIG. 10 is a block diagram schematically illustrating a preferred software procedure for using installed DRM protected digital content under media localcasting system control;

FIG. 11 is a block diagram schematically illustrating a preferred software procedure for using installed DRM protected digital content outside of media localcasting system control;

FIG. 12 is a block diagram schematically illustrating an exemplary hardware configuration of a multizone music localcasting system which can advantageously utilize the present invention;

FIG. 13 is a table showing an exemplary data structure for user profiles; and

FIG. 14 is a block diagram schematically illustrating the procedure for automatic gap fill searching.

### DETAILED DESCRIPTION

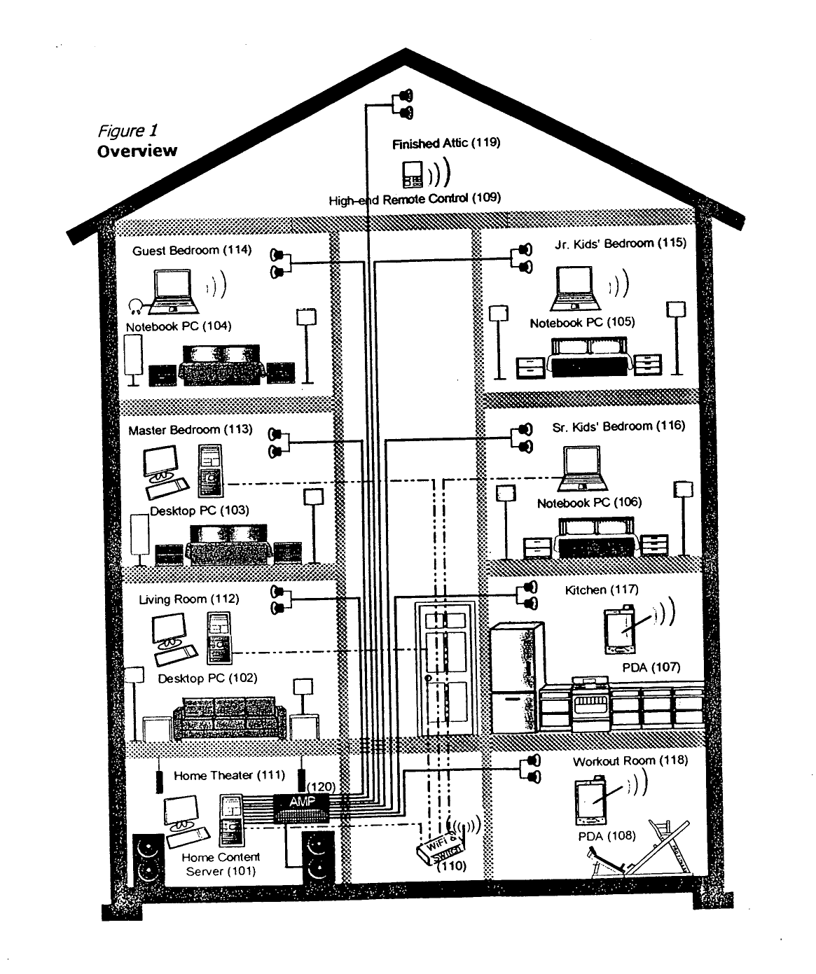

FIG. 1—Overview

FIG. 1 depicts a typical content, or media, server and an array of clients connected via various wired and wireless links in an exemplary home environment. The system of FIG. 1 can be operated under software control in accordance with the invention to function not only as a conventional multizone music localcasting system (MZMLS), but also to more effectively manage protected digital content. Important details are provided in subsequent figures, but this overview is offered to provide a high-level illustration of what's happening, so that the lower level details can be more readily understood.

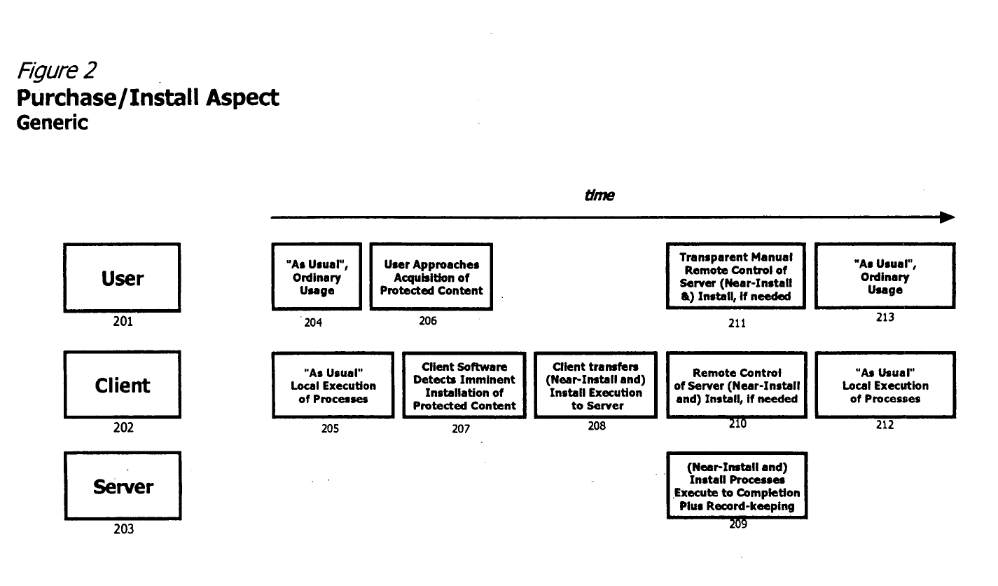

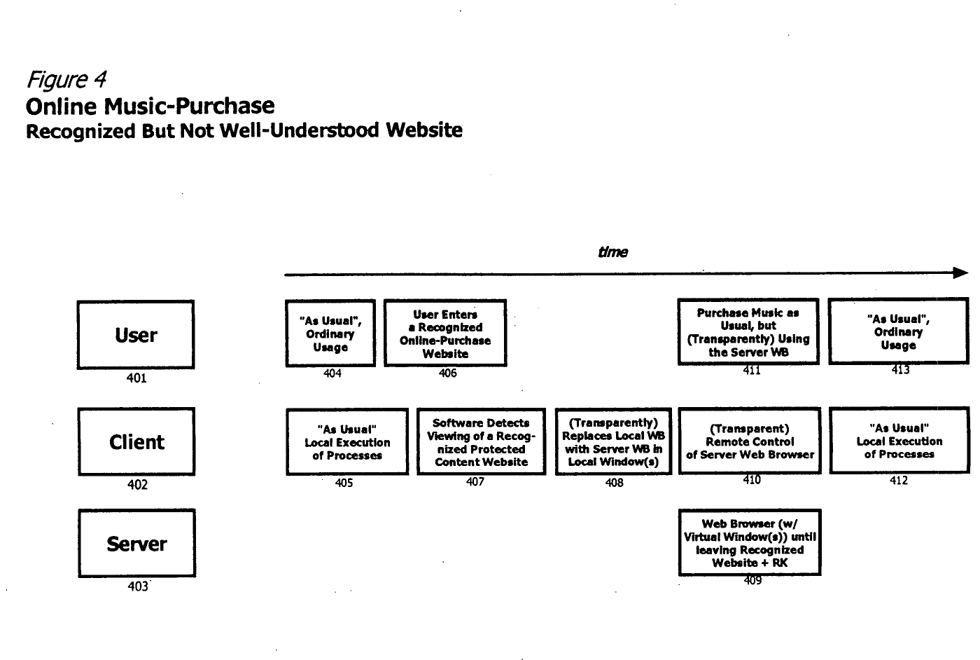

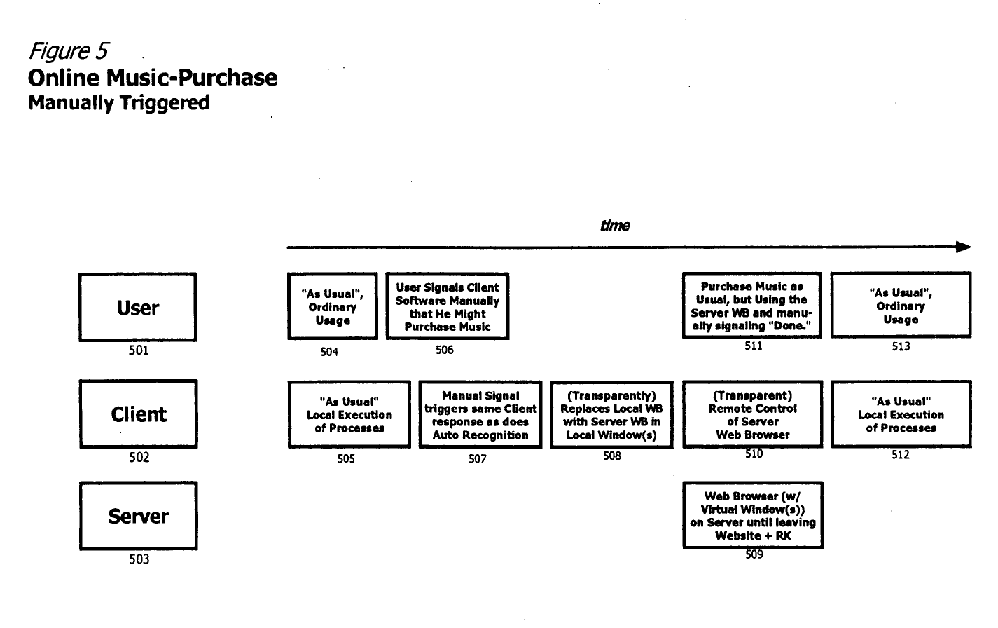

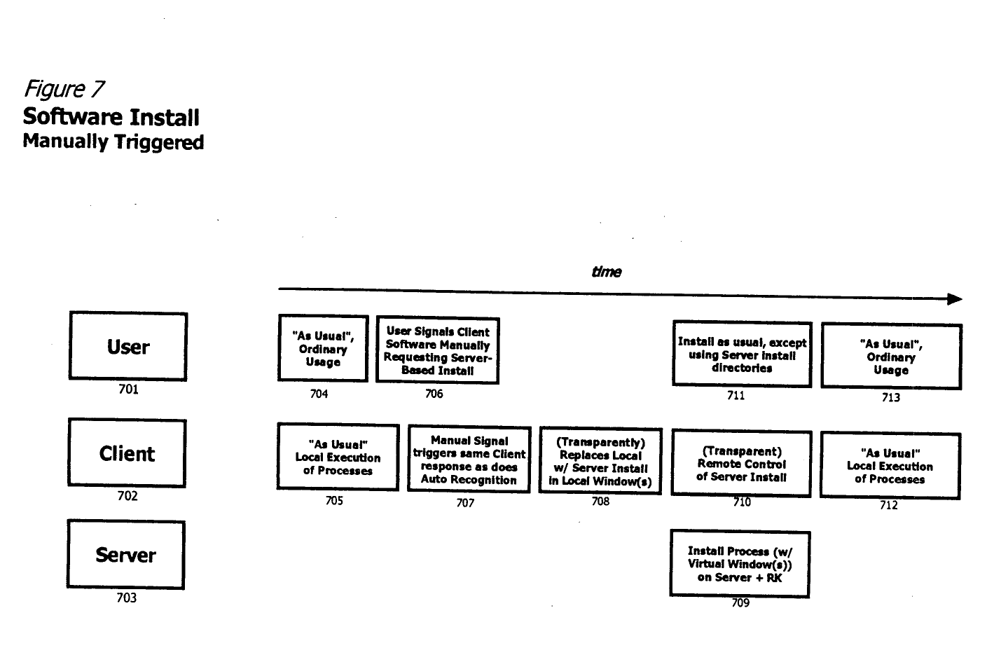

A content server (101), any suitably powerful and capacious desktop or even notebook computer, is the storage and processing center for all content (music & video, e-books, software) and settings (licenses, library indices, purchase records, playlists, user profiles, etc.). It processes I/O over the home's local area network and also outputs audio via a multichannel amplifier (120) and analog wiring to speakers in each zone (111-119). The server (101) can be accessed via its own keyboard and display, but is more commonly accessed via any of a variety of client devices (102-109), connected to the server via wire or wirelessly. Server content can be purchased and/or installed directly on the server, but preferably, in accordance with the present invention, automatic (FIGS. 2, 3, and 6), semi-automatic (FIG. 4), or manual redirection (FIG. 5 and 7) of client purchases and installations to the server will be used.

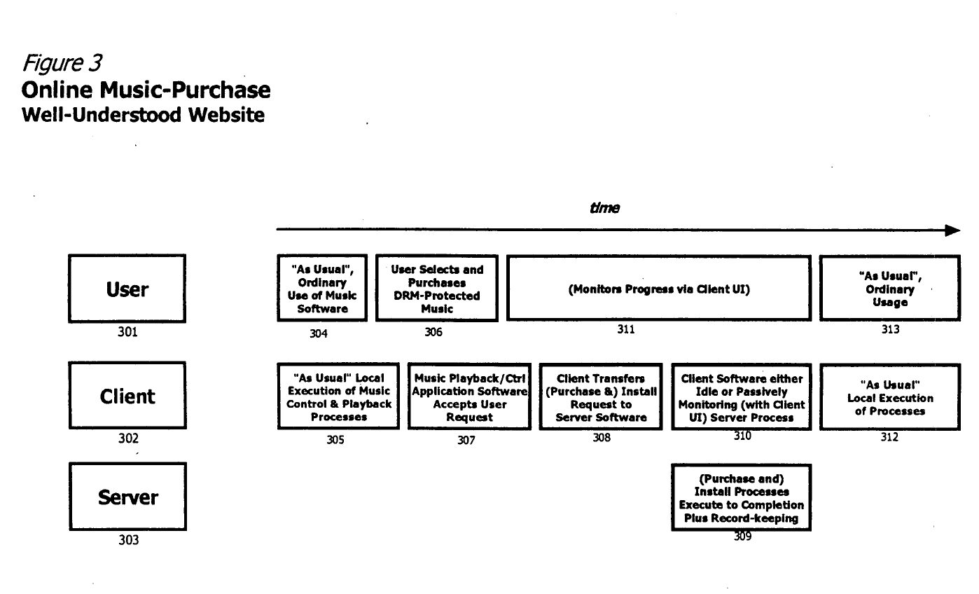

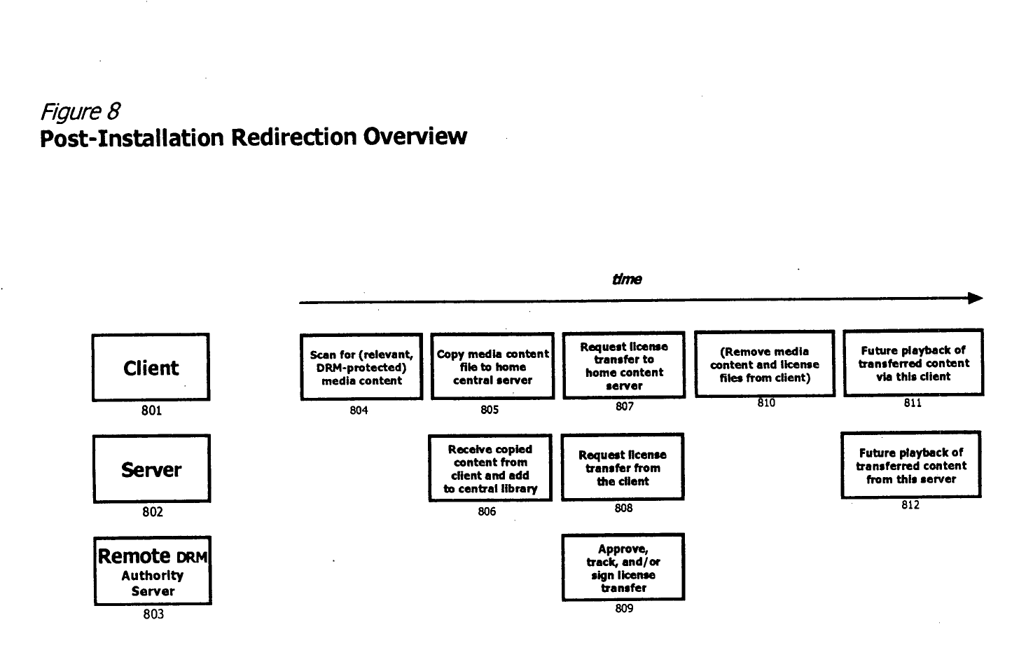

For example, users of the client desktop PC (102), connected via cable to an Ethernet switch (110) which is in turn connected to the server (101), in the living room may decide to purchase some music online from a website that the software in accordance with the present invention understands very well (FIG. 3). As a result, that music becomes available anywhere in the home and, in the case of DRM protected music, in a novel way via FIGS. 8-10, and indeed any zone (111-119) may be controlled from this PC 102.

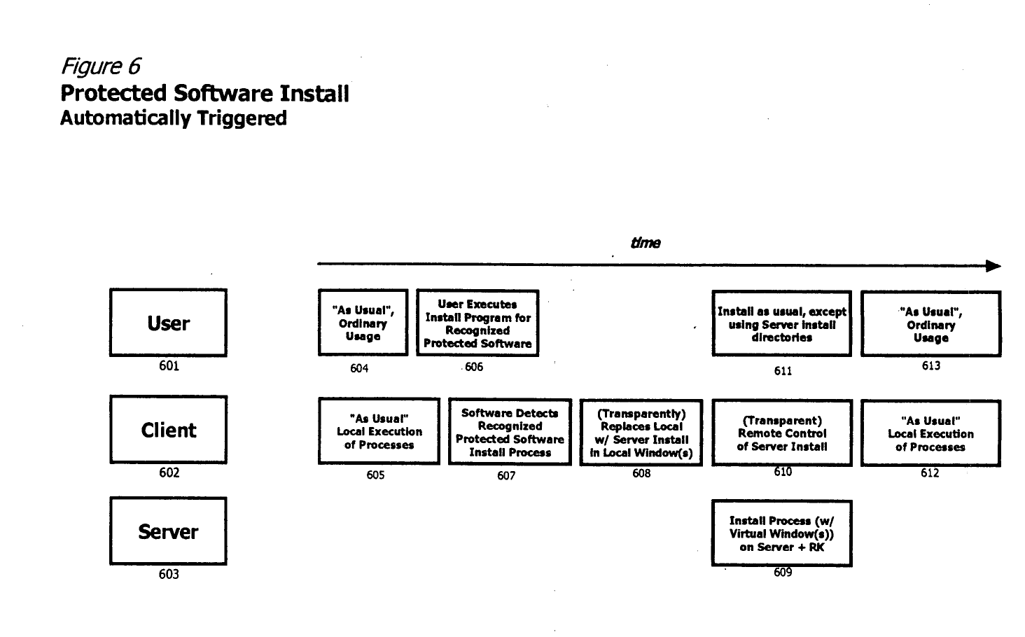

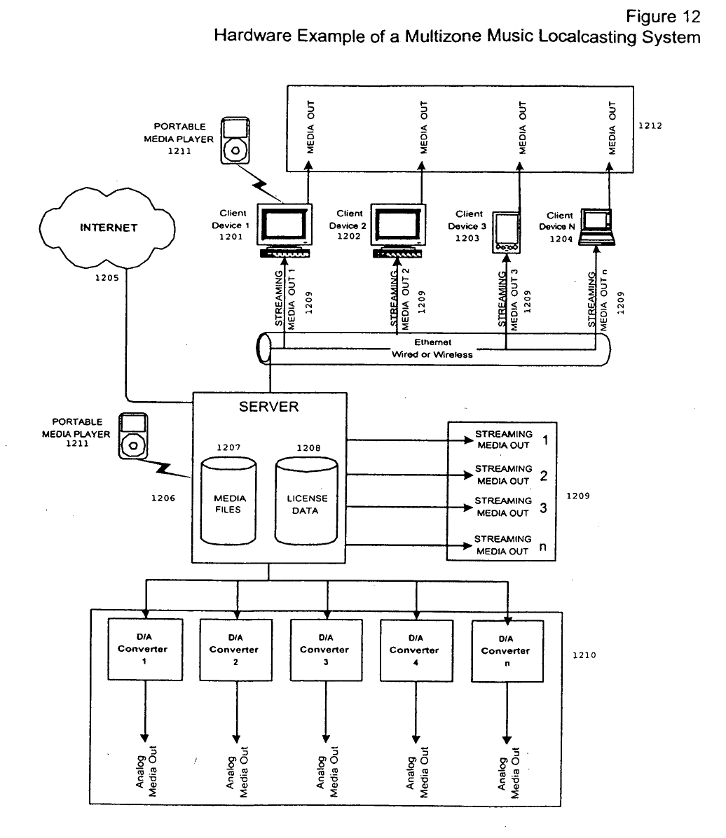

At the same time, the user of the client PC (103) in the master bedroom (113), a parent in the household with a user profile to match, is able to override the zone settings specified by an inferior profile (see FIG. 12) and cut the volume in the older kids' room (116) to protect the kids' hearing and the household's sanity. Mental health being preserved, she then installs some protected software using the invention (FIGS. 6 and 7), thereby ensuring that she, a legitimately licensed user, can use them in other rooms in the house too.

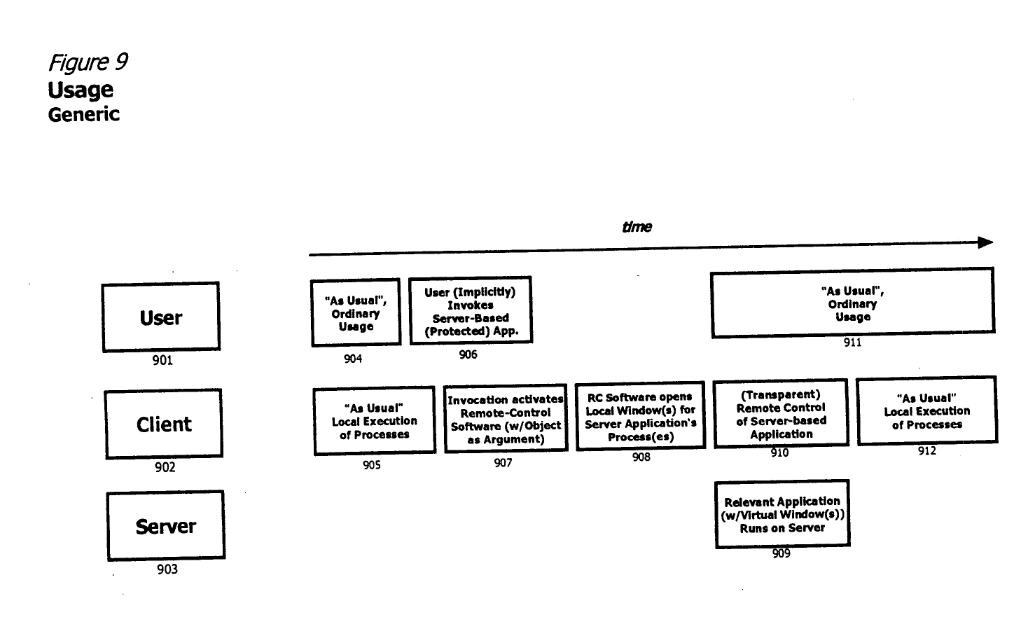

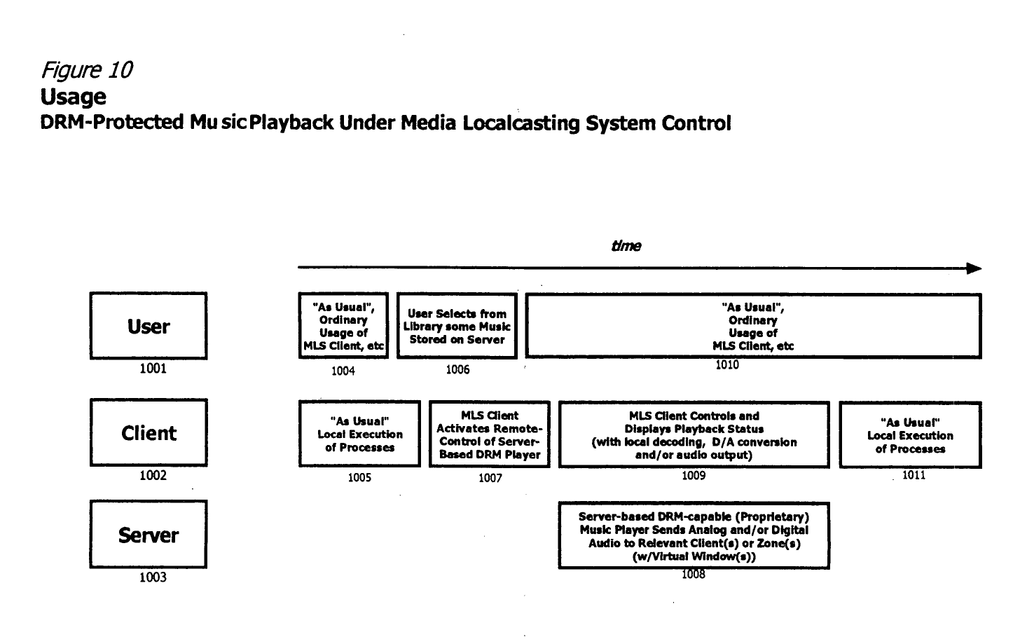

Again at the same time, a guest in the guest bedroom (114) with the invention's software installed uses his notebook (connected wireless to the Wi-Fi wireless router and switch) (110) and connected headphones (104) to play (FIGS. 9 or 10) one of his host's albums—perhaps a DRM-protected album, unplayable without the invention—from the server (101) via streaming, at no point being able to save or purloin the content, nor to play it after he leaves the house, to his considerable chagrin.

Meanwhile, in the older kids' room (116), with the parents' having turned the volume down so low it's hard to think, the daughter nonetheless uses a word processor via the invention (FIG. 8), which means her old desktop computer (106) doesn't need a copy, which is good because it's not really powerful enough to run it, yet it's fast enough to display the remote control window over a LAN with no worries. If she saves the document to the server, too, then she can seamlessly move her work to the living room's computer (102) when her favorite cable public access television program comes on after dinner.

In the kitchen (117), the college student son eats a snack, between bites purchasing some alternative music online using his wireless PDA (107) through the home content server's MZMLS system user interface (FIG. 3).

In the workout room (118), a daughter exercises to some high-energy iTunes and a volume setting to match, as set by her wireless PDA which is also a client (108), which has a profile allowing it to set the volume in any zone (111-119), subject to profile limits and parental override, of course.

Finally, up in the attic playroom zone (119), the kids and their friends use a common deluxe wireless remote control (109) that has its own “user” profile that controls only that zone and only within certain volume limits.

FIG. 2—Purchase/Install Aspect

FIG. 2 generically depicts how the software in accordance with the invention deals with purchasing and installing content; a series of subsequent figures further explain, particularize, and embellish this basic idea.

It's comparatively easy, though still novel and useful to automatically (i.e., whenever a CD is inserted, or with a different preference set, whenever the “ripping” process is started manually) to install the content from an audio CD not onto the client (as Windows Media Player has a checkbox to do, e.g.) but instead onto the home content server, each relevant client device then contributing to the home, rather than merely its own, content when a CD is inserted or “ripped”. (Integrating such music with the library can either be done as part of the installation process or by running a server-side scan of all available content--both are prior art with respect to music on the client.) This can be done on the client itself with the destination ripping directory on the server, home content server software then adding the music to its internal library. But dealing properly with DRM-protected software and music is a much more challenging matter, requiring the more sophisticated aspects of the invention.

In FIG. 2, the invention's software on the client monitors system activity to intervene whenever a protected content installation is likely imminent (by any of several means noted in subsequent elaborative figures). When such is detected, the invention software shifts actual install-related execution (though not ultimate control, unless the installation is fully automatic) to the server until the installation on the server (particularly any installation details involving DRM, such as DRM license installation [whether via separate license files or integrated license information within the content files]) is completed, execution then being returned to the client.

“System fingerprinting” or “individualization” of the DRM license or copy-protection is performed on the home content server by redirecting the relevant process execution from the client to the server.

This aspect of the invention can usefully be broken down into three streams of activity: those of the user (201), the client device (202), and the home content server (203). With the client and server waiting for commands, the user, directly interacting with the client, is interacting “as usual” with the client device (204, 205), when he considers buying or installing some protected content and interacts accordingly with the client (206). The client detects this potential (207) and transfers (i.e., initiates or re-initiates) the install (and, if relevant, install-related [e.g., web browser]) process (es) to the server (208). Said processes then execute on the server (209), under the remote control of the client (210) and further, the user (211), if appropriate, so long as the install/near-install process (es) run on the server. After they complete (i.e., that the condition in boxes 206 and 207 no longer obtains), execution (212) and usage (213) resume “as usual”.

(It's important to note that every case of parenthetical text in the figures is an instance of optional status or optional activity included to avoid the unnecessary proliferation of figures for minor variations.)

FIG. 2, then, depicts the generic version of the first main aspect of the invention. But to better understand the scope and utility of the invention's first aspect, several more-concrete versions will be disclosed.

FIG. 3—Online Music-Purchase-Well—Understood Website

FIG. 3 depicts a variation on FIG. 2 focused on purchasing music (here, as usually, it could be any sort of digital media content) online from a well-understood website for a home media server library. It does not involve deviations from FIG. 2 so much as elaborations on it—it is an instance of FIG. 2 for a specific, concrete purpose.

Typically this scenario occurs from within a particular media-playing-and-controlling client software environment—this is what motivates the “well-understood” aspect, since typically the purpose of a deeper understanding of a given website is to allow the client and client's user to control the purchase through the client's own user interface (for aesthetic, functional, and marketing reasons) rather than an ordinary web browser that's fundamentally unrelated to the media-and-playing-and-controlling software on the client. Sometimes part or all of the target website will be specifically designed for machine-control (e.g., formatting and structuring particular aspects of website input and output for computer- rather than human-interaction—a given if the website were designed to cooperate explicitly with the invention's client), but a sufficiently well-understood website can be controlled by client software even though the website is optimized strictly for human browsing of the site, though the details of such control will vary utterly from site to site and time to time and, fortunately, are not an object of this invention.

FIG. 3 begins as usual, with a user (301), client device (302), and home content server (303) as in the previous figure, and the “as usual” use of the media playback and control software (304) executing locally on the client (305). But then the user selects some music to purchase (306)—not in this case through a generic web browser (though, as FIGS. 4 and 5 show, that's entirely feasible), but through the client's media playback and control software (307) (which may have capabilities such as “find more music like this”, “find other songs or albums by this artist”, “find other music of this genre”, “find the most highly rated music of this genre”, “find music via alphabetical search”, and so forth; of particular interest would be a “find music by this artist or classic/important music of this genre that I do not already have” search, more on which near the end of the disclosure), which greatly simplifies purchasing for the user and potentially generates income for the software publisher from a purchase referral. (Sometimes DRM-protected music will be free, in which case the installation component proceeds without any or with a zero-cost purchase, so far as server recordkeeping goes.)

With the user monitoring the progress as displayed by the client (311) (which may include such details as credit card transaction progress, data download and install progress, etc—or may keep the user blissfully in the dark about the inner workings, particularly if the whole process is swift or the user not interested, perhaps displaying only album cover art, or a progress bar, or even returning immediately to “as usual” usage), the client software transfers the purchase (when buying music) and install request to the associated server-side software that's part of the media playback and control system (308).

The server then executes the erstwhile client-side purchase and install processes (309), plus any necessary recordkeeping (e.g., not merely installing the downloaded music onto a hard drive, but recording the purchase (who, what, where, how, and at what price, e.g.) in a purchase history database, noting the existence of the new music in the appropriate categories in the system's music library, tracking the license/DRM data for the newly received content, and so forth). (The details of the purchase, install, recordkeeping processes are both highly variable and, while the invention essentially builds upon them, are not themselves objects of the invention and so are not disclosed here.) The client software (310) either simply waits for the server to finish, or usually passively monitors the associated server-side processes so as to display progress for the user (311). (If some user interaction is required by the server in this “well-understood” scenario, this too is of course passed on from the server to the user via the client software.) When the server side process (309) concludes, the client (312) and user (313) return to business as usual.

FIG. 4—Online Music-Purchase—Recognized But Not Well-Understood Website

FIG. 4 changes FIG. 3 fundamentally in this important respect: the music purchase is from an automatically recognized but not well-understood website, i.e., the invention can automatically detect that an acquisition of protected content (in this case, music) may be near based on some list- or analysis-based knowledge that it's sold by or merely downloadable from a given website (i.e., domain, subdomain, subdirectory, page, etc.), but the knowledge of the web-based purchase and install processes for this particular site is not sufficiently intimate to handle said process purely automatically through the client software user interface. So what's to be done? Basically, let the user understand the web site and run the web browser himself, except that the web browser is (more or less unbeknownst to the user) running on the server instead the client, thereby transparently transferring the purchase and installation processes and data to the server.

This detection and redirection part of the invention's software would typically run on the client, but in principle it could as well or even better run on or in programmed cooperation with the router or gateway, this option permitting more “fine-grained” transference of sessions from the client to the server: by controlling NAT on the router, e.g., the same external, WAN-exposed ports could be internally reassigned to the server or the client as desired on a moment-by-moment basis even within one website's session or page; otherwise, if we use an unmodified, off-the-shelf router and run the detection and redirection software just on the client in cooperation with the server, it's simplest to transfer sessions at a “macro level”, i.e., effecting the redirection as soon as one goes to a purchase site or set of pages [so that every part of every page on the site or in the set, respectively, would be viewed on the client via redirection and remote control, the browser and any child processes executing on the server]. The only downside to the router-based, “micro level”, fine-grained approach is that it requires reprogramming of a router, which is not at all a trivial task if one seeks a low cost hardware/software solution.

As usual, we have the user (401), client device (402), and home content server (403), running things “as usual” (404, 405).

“As usual” operation is a bit broader here than in FIG. 3, in that FIG. 4 permits but does not require that this happen in the context of media control and playback software, the requirement minimally being that software is running that detects web activity on the client and is able to detect when a recognized but not well understood website is entered. This may happen from within the context of the media control and playback (via exercising an option to purchase music but not selecting a well-understood source, this option typically and here from the user's perspective simply opening a web browser on the target URL's page), or it may happen just in the course of generic web browsing (by navigating to a recognized but not well-understood website using any browser with a suitable URL-monitoring browser-plug-in or background process, a plug-in or process required for this aspect of the invention but not itself an object of the invention).

While focused on recognized but not well-understood sites, this generic web browser approach could also be used with a well-understood website. Typically, as covered in FIG. 3, such websites are preferentially accessed by the client media control and playback software or something similar so as to extremely simplify the purchasing process, this simplicity motivating the effort to well-understand the target website. However, the generic web browser approach is still useful even for well-understood websites should the user make a purchase outside the influence of the media playback and control software. If the user simply surfs to such a site on his own, then FIG. 4's version is useful even for a well-understood site.

This approach is also useful if a target website changes from well-understood to not-well-understood without the invention's knowledge—if errors are detected using the approach in FIG. 3, the program can then automatically switch to the approach in FIG. 4.

So then, when the user goes to a recognized online-purchase site (406), the software detects this (407) (if via a browser plug-in a background process, immediately after the user surfs to the site, as shown; if instead via the media playback and control software, possibly immediately before, since said software typically “knows” whether the site to which it's directing the user is recognized) and, in cooperation with server-side software, creates a local remote control window replacing the relevant existing local browser window, if any. (Fortunately, it is technically feasible to monitor new window and new process creation at the server, so if the server-based installation processes opens any additional windows during installation [new browsers or new processes in particular], those windows too will be remotely displayed/controlled at the client after the server notifies the client of such [assuming the windows are visible, versus invisible or hidden].)

Since the user may start his browsing at the recognized site via any of media-playback-and-control software commands, desktop or start menu shortcuts to the site, etc., there might not be an already opened web browser, in which case the user starts off with the remote control window. Alternatively, if the user navigates to the recognized site through a web browser, the browser is replaced by “minimizing” or terminating it (or possibly instead co-opted by displaying a page running ActiveX, Java, etc. software objects that can effect remote control via the browser itself), a new remote control window (408) interactively displaying a server-based web browser (409) newly started by the server component of the invention. (Very preferably, just the browser window is so displayed, not the entire server desktop [as is the case with the most generalized forms of remote control software], the window on the server optionally being a “virtual” window that physically displays nothing on the server's physical display). That the execution is on the server will (except on unusually low performance home LANs) typically be substantially transparent to the user.

Since the potentially purchasing and installing browser is actually executing on the server (and merely observed and controlled on the client), should the user actually purchase and install some music, the consequences are borne by the server and not the client. The server receives the installed music file, and the server receives the (often non-exclusive but limited-quantity) license. From the relevant websites' points of view, the server is the client. This simplifies license management and hence, in the increasingly DRM-ruled world, music (etc.) management, substantially.

When the user completes his use of the site, either by navigating to another site or by closing the window, the special handling ends, and things run “as usual” (412, 413).

(Note that the mentioned “remote control” is very similar to that effected by existing multi-user and remote control software packages and is not per se an object of this invention.)

It's also possible to have an interesting variation of FIGS. 3 (recognized and well-understood) and 4 (recognized but not well-understood): not recognized and yet relevantly well-understood.

This situation could arise when an as-yet unrecognized website is discovered (via a browser plug-in or background monitor process) to use certain recognized, off-the-shelf components (e.g., particular Java or Javascript classes, particular HTML or especially XML structures, etc.) with which the invention can interact. Depending on the nature of the invention-recognized component, the invention might redirect the entire browser session to a remote-controlled browser actually running on the server, as in FIG. 4; or it may instead simply redirect the install and related processes themselves without relocating the browser process, similar to what is shown in FIG. 3 (though without the invention client user-interface).

FIG. 5—Online Music-Purchase—Manually Triggered

FIG. 5 is similar to FIG. 4 with one particularly important exception: in FIG. 5, the purchase/install website is neither well-understood nor even automatically recognized, and so its status as a purchase/install site is manually recognized (and understood, as in FIG. 4) by the user.

Why bother with manual recognition? Simply to engage the invention and redirect the installation of the content and the license to the home server, whence it may be accessed anywhere in the home.

The user (501) uses the client device (502) “as usual” (504), i.e., for whatever he wishes with the processes executing locally (505), the home content server (503) initially not involved (so far as this version goes—there's no reason, of course, other client and server software couldn't be running in- or inter-dependently, but they're beside the point for this disclosure).

Then something unusual (relative to previous versions) happens: the user manually signals an intention to acquire music online (506) (it could absolutely be any protected content [e.g., protected software—see FIG. 6], of course, but in this version, it's music). The client software responds to this manually recognized website, recognition-triggering mechanism aside, in precisely the same way (507-512) it would to an automatically recognized website as shown in FIG. 4 (407-412). The manual triggering comes on both ends of the remote control period: just as he manually started it, the user must manually end the web browser purchasing/installation session (511). The precise software method of the signaling (e.g., menu choices or buttons within media playback and control software, or in a browser customized toolbar; or a triggering program run from the Windows Start Menu; or a command or toggle initiated by a “hotkey”; etc.) is not a primary concern and so is not elaborated.

FIG. 6—Protected Software Install—Automatically Triggered

FIGS. 6 and 7 depict the invention as applied to installing protected software, FIG. 6 showing automatic recognition (parallel to the automatic recognition of protected-content-installing websites in FIG. 4), FIG. 7 showing manual recognition (parallel to FIG. 5).

The initial states (601-605; 701-705) are similar to those in previous FIGS. 2-5, except here, the focus is explicitly on protected-software installation.

In FIG. 6, the user executes an install program (e.g., “setup.exe”, “install.exe”, or “*.msi”) (606) which the invention software recognizes (from in internally or externally stored list, e.g.) as protected (i.e., once installed here, can't be easily installed elsewhere in the home) (607). The method(s) of recognition will vary with the software being recognized: in some cases, an installation CD volume name will indicate the precise software being installed; in others, the name of the install program (particularly with “*.msi” files); in some online instances, the identifier will be the name of the downloaded installer or metainstaller (i.e., the solitary downloaded file that decompresses into a set of normal installation files), or the URL of the download; the time, date, and size are also powerful and jointly compelling identifiers (barring pointless spoofing); also, plaintext comments within the executable install files often reveal the program and version; and so forth.

Once the fact of an imminent installation of protected software is detected (607), the invention software proceeds characteristically (608), precluding or (if necessary, i.e., if the installation is detected not at invocation-time but run-time) terminating the local installation and replacing it locally with a remote control window (610) interacting with a server-side instance of the same installation process (609) (running from the same source, e.g., a given website, or a particular client media reader [CD-ROM, DVD-ROM, USB, etc.]), with- the relevant recordkeeping necessary for shortcut sharing for other clients in the house. For the user, the change has practically no impact: while the target installation directory, typically displayed during a Windows program install process, will be on the server rather than the client, the filespec will commonly be identical (e.g., “C:\Program Files\Acme Corp\Sample Application”—the fact that drive C is now on the server rather than the client is transparent). When the install process terminates, client processing returns to normal (612) and the user continues as before (613).

Note that a certain difference arises if the installation is via download from a recognized protected-content website: in this case, the installation run as in FIG. 4, but for software rather than music, and the extra step of terminating a local install and replacing it with a server-based install is unnecessary, since the processes triggered by the server-based web browser will themselves also be run on the server.

Note too that in some cases it may be desirable to have the invention recognize and install on the server software (as noted earlier with content generally) that is not protected—while this is not essential, since the software, being unprotected, and assuming the license permits as much, may be installed on another computer in the house—it may simply be more convenient.

FIG. 7—Software Install—Manually Triggered

FIG. 7 is extremely similar to FIG. 6, the single conceptual change being that the user rather than the invention's software recognizes the protected install and requests that it be executed on the server (706, 707 versus 606, 607). This allows the invention to help users even if the installed protected software is not recognized by the invention; it also allows the user to use the invention on unprotected software, if he wishes (to save storage space on the client, to run anywhere in the house with only one installation process to go through, to keep the kids from messing it up on the client, etc.).

To this point the focus has been on installing protected content onto a server rather than onto the client which is effecting the installation. This first aspect of the invention is complemented by the second, that of taking the protected content, installed by the invention on a home server, and using it from various clients within the home. It's that aspect on which we focus now.

Note well that even though from a user's perspective usage and installation are radically different processes, the methods used by the invention for each are surprisingly similar, which simplicity and commonality practically enhance the process and result of designing and implementing an actual embodiment.

FIG. 8—Post-Install Redirection

Up to this point, the focus has (quite properly) been on redirecting the installation process itself to the central server. However, there's another approach that can sometimes be taken which is in some respects much simpler and more straightforward: install first, completely normally, then move things to the server. What could be simpler?

The complexity comes when DRM is involved. If a music (or other content) file with DRM is simply moved to another computer, it simply doesn't work there. Similarly, if both the content file and the license file are moved, the content in the file is not accessible there. When moving DRM content from one installation to another, one must re-configure the license to work on the target computer, almost always with assistance from a remote DRM server associated with the publisher, seller, or other relevant trusted authority. Ideally, this remote DRM authority will revoke the DRM license on the original computer and reissue the DRM license on the new, target system, keeping the count of available installations for the media content unchanged; more commonly (for sales-inducement and DRM-hacking-avoidance reasons) the DRM authority will keep a license on the source machine and simply consume another license-permitted computer when installing on the server, decrementing the count of permissible systems by one.

The matter is further complicated because this may not be permitted at all by a given license or DRM technology, and because each different DRM technology will (typically) require different software with different parameters contacting a different remote server to successfully transfer or add the media content to another computer (i.e., in this case, the home content server).

But while this approach lacks the DRM-type- and Remote-DRM-server-independence of the earlier approaches, it's still often feasible.

FIG. 8 shows, in a schematic way leaving out the details of different DRM systems' technologies, how this would work. (The DRM-type-specific details are critically important for an actual implementation, but are not objects of this invention.) Post-install redirection could be done in real time, as media content are installed on the client system (a note on which appears below), or, as in this figure, in batches, upon user request or upon installation of the invention (this mode would be particularly desirable when a preexisting client base of DRM-protected media content were to be transferred shortly after setting up the invention's home content server, e.g.).

At a user's request (though it could alternately be automatic, as noted above), the invention client (801) scans (804) for content to transfer. This scan may or may not have various parameters (only certain kinds of files: MP3s, MP3s protected with a particular kind of DRM, all media content files, etc.). Once found, the files are copied (805) to the home central server (802), which receives the files (806) and adds them to the central library (at least for the user in question, other users' access depending on their profiles and permissions).

The next part is the tricky part that will vary with each DRM technology and the parameters used within that technological envelope. It's shown as occurring after the copying, but it's possible (in otherwise identical embodiments) for it to occur simultaneously or even beforehand—the step is logically, but not necessarily sequentially, distinct. The invention client requests a transfer (807) of the license to the home content server, typically by calling or controlling software created by the DRM technology provider. The server (802) receives the media content making a parallel request to DRM-technology-provider software for a new license for itself. In each case, it's likely the DRM-technology-provider software will “phone home” to a Remote DRM authority server (803) to validate the creation of the server-based license for the given media content (and in some cases cancellation and recovery of the client-based license). After successful completion of this step, the media will now be directly playable on the server (802) or, as described in subsequent figures, indirectly from any client. (8(8

Optionally, and even preferably, to avoid wasting instances of a license on a computer that will not be used to decode or process the content, the client-instance license will be cancelled by the remote DRM authority server, permitting said instance to then be used on another computer. In this case, the client media content and license will be uninstalled, the content still being usable via the invention. Unfortunately, some DRM systems do not facilitate recouping a license instance.

FIG. 8 shows the “batch mode”; such transfers could instead take place automatically upon installation of new media content files. This would require a background process to monitor such installations (by monitoring relevant file creations or by monitoring calls to the DRM technology provider software—like a media content firewall watchdog), but otherwise the procedure would be substantially similar or identical.

FIG. 9—Usage—Generic

On the usage side, the invention comes into play typically when the user actually begins to use the protected content previously installed by the invention, whether this content be data (as with music, video, an e-book, or other media), in which case it's processed substantially transparently on the server with remote control from the client, or software, in which case it's executed in the same remote-control way—very reminiscent, were it necessary to point out, of the way the content was installed to begin with. (In principle, of course, the content could have been manually installed on the server without use of the invention—that would work too, so far as usage via the invention goes, but would not be the most convenient and hence not the typical case.)

FIG. 9 depicts usage's (i.e., the invention's second aspect's) generic case. As in FIGS. 2-7, we start with the triplet of the user (901), the client device (902), and the home content server (903), and as usual, things begin with operation “as usual” (904, 805) (i.e., as though the invention weren't involved, so processes generally operate locally with no client-base remote control of server-based execution).

Whether the content the user is using is data or software, the attempt invokes some server-stored application (906)—the user needn't have any awareness that the application is stored on and (more importantly, so far as DRM/protection handling goes) executed from the server.

The invention software reacts (907) to this user invocation of a server-side application in a way very similar to previous figures' showing it reacting to the user's installing protected content: a remote control window is opened on the client (908), and on the server side, the invoked application executes (909) ideally, but not necessarily, in one or more virtual windows not physically displayed on the server's display), the user using the invoked application (911) more-or-less as though it were local (910) via the remote control program window. When the server-based application ends, things return to normal on the client (912) with local execution of processes, though typically from the user's perspective things will not return to “as usual” but continue as usual (911). Obviously, the core of the usage side of the invention is similar to the installation side, which simplicity increases elegance and eases implementation.

FIG. 10—Usage—DRM-Protected Music Playback Under Media Localcasting System Control

FIG. 10 makes usage more explicit in the paradigmatic case of playing digital music (and thus also a case of implicit invocation via activating a [perhaps transparently] server-stored object), with the same triplet of user (1001), client device (1002), and home content server (1003), and the usual “as usual” use by the user (1004) and the client (1005), though this time explicitly in a music or media localcasting environment (which environment is at least media-centric special software, and commonly media-centric special client hardware as well, emphasizing simple yet detailed control of media playback).

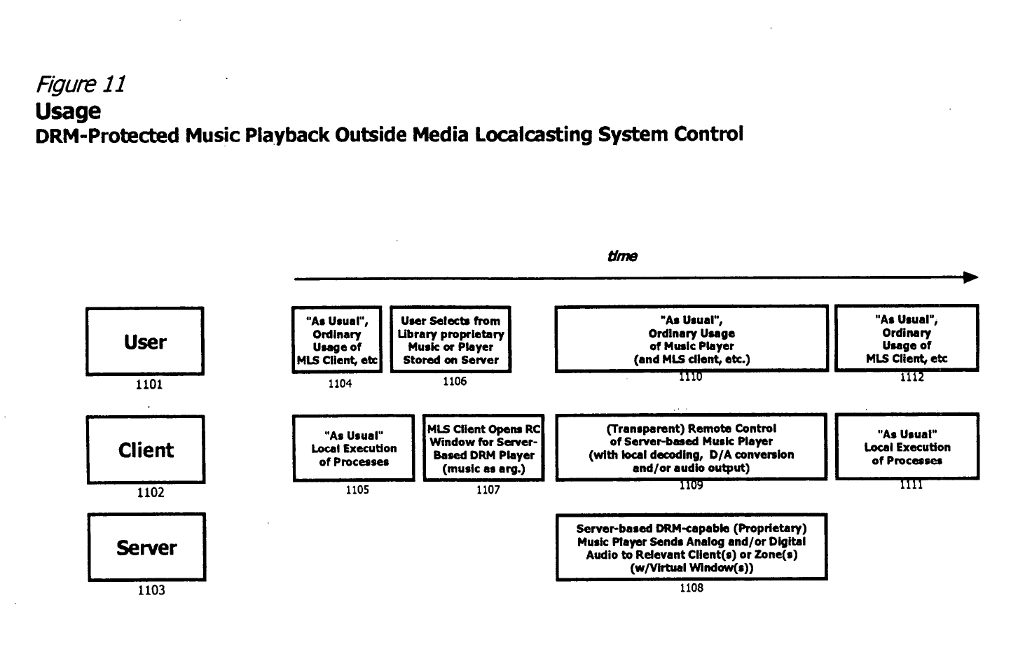

Using the media localcasting software, the user selects some music for playback (1006)—either songs directly, a saved playlist, or a random selection, e.g., in this example the music, perhaps unbeknownst to the user, is stored on the server and is thoroughly protected against illicit copying via DRM technology. The client software then activates a remote control relationship (not necessarily, in this case, a particular window) for a relevant=DRM-compatible media player (1007), said player (often proprietary, as with the Apple iTunes player) executing on the server (1008), ideally but not necessarily in a virtual window as described earlier. (Some proprietary players will be limited to one instance, others multiple, both here and in FIG. 11.) In this example, and ideally, the client media localcasting control software directly controls the particular server media player being used to play the particular content selected (1009). Hence, the process is transparent to the user (1010): from the user's perspective, nothing unusual appears to have happened, and the music (or other content) playback appears to be via the normal client playback software (and in this case, the appearance is much more important than the reality—at least so far as user convenience goes). When use of the server-based player ends, the client returns to local execution “as usual” (1011), but from the user's point of view, things were “as usual” all along.

(Typical music localcasting systems will not be limited to the invention's novel aspects, of course. Particularly for non-encrypted and non-protected content, the MZMLS system itself can play it back directly with no need to use any proprietary player. On the other hand, this is also why conventional MZMLSs play no protected content at all—because they don't have the capabilities of the invention, only the standard, comparatively simple capabilities given by prior art.)

FIG. 11—Usage—DRM-Protected Music Playback Outside Media Localcasting System Control

Sometimes the ideal is not the real, however. For any variety of technical, corporate-political, or even legal reasons, sometimes it's difficult for the client software and the DRM-enabled player on the server to cooperate closely enough to let the client media localcasting software transparently control said player. FIG. 11 gives a practical fallback, using the server-based media player a bit more generically, as in FIG. 8. With the usual assumptions (1101-1005), the user selects from the server-based library (1106), selecting some particular music (which we stipulate, only for this figure, happens to be music that cannot be played by the default or indeed any MZMLS-controllable player) or (it's up to the user) player (the choice perhaps being limited to players both for which there is content and which are not directly controllable via the MZMLS software). This user choice induces not only a remote-control relationship, as in FIG. 9, but a remote control window (1107), as in previous figures, for the explicitly or implicitly chosen DRM-capable media player, which (known or unknown to the user) executes from the server (1108).

FIG. 12—Hardware Example of a Multizone Music Localcasting System

In FIG. 12, both the server-side player (1008, 1108) and the client controller (1009, 1109) deserve a bit more elaboration, since there may be more going on than previous figures would lead one to expect. In a music localcasting system (and, mutatis mutandis, in a video localcasting system), the goal is playing music, and that's not just software: somewhere, somehow, actual, physical sound must be produced, and since it's produced under MZMLS control, it's connected somehow with the server and/or a client. This production of sound can happen in a variety of ways, none of which in isolation from the rest of the invention are objects of the invention (since all are, in isolation from the rest of the invention and broadly construed, prior art), but any of which can be nicely integrated into a concrete instance of the invention.

The variety of output steps include:
Validation of license (if applicable)
decryption of content (if applicable)
decompression of content (if applicable)
Routing of content (to one or more chosen zones in the house)
digital output
digital-to-analog conversion
analog output
   Line-out or amplified
      Any of these steps can, in principle, be accomplished on the server, on the user's client, or even some other client (under the direction of the user's client or the server). There are too many possible hardware permutations here to consider them all explicitly—focusing on a representative example of a very concrete embodiment of a music localcasting system using the invention will be helpful, and we will do so in FIG. 11.

In FIG. 12, a representative example of the hardware used to implement the invention, the core is the home's central localcasting server (1206), which stores the media files (1207) and the license information (1208) (in some DRM schemes, such as Microsoft's, these are separate files; in others, the license will be integrated into the media file itself, or possibly put into the system registry). The server is controlled by its own software's interaction with client devices (1201-1204), which clients are in turn controlled by users (not shown here because of this figure's focus on hardware). The users use a given client for some combination of purchasing or installing content (on the server, as described in much greater detail earlier); controlling playback (content selection, volume, equalization, physical or virtual zones, etc.); outputting client (via analog or digital output to, in the case of music, speakers); monitoring server, client, and zone activity and status; and downloading to players (1201, 1211), depending both on the desires of the user and the capabilities of the particular client. In this example, the clients are connected via Ethernet, but they may easily also be connected wirelessly, or even by USB or other serial connection. The server (1206) has a connection to the Internet (1205) for purchasing and installing content, and for license verification as needed. The server plays back its content by any of several means. First, it can act as something of a client and download music into a portable music player (1211) (paradigmatically the Apple iPod, but any will do), though more often this would be done from the server via a client as noted above (1201). Otherwise, in a traditional multizone analog audio approach, there are arbitrarily many analog audio outputs (1210) as cost-effectively desired, this audio then typically being routed around the home using ordinary coaxial cabling to an amplifier connected to the relevant number of speakers (anywhere from one, in a low-end or tight space environment, to seven or more in a home theater environment). Alternately or additionally, one can digitally stream content from the server (1209), similarly to an arbitrarily large quantity of zones. Such streaming can be done over standard Ethernet, wirelessly, or via Firewire, USB, or other digital serial or parallel connections. The recipients of this streaming can be either dedicating digital audio receiver clients, or the regular client devices used also for user control of the system (1201-1204), these recipients then either forwarding the streams to another more ultimate client or, typically the ultimate clients themselves, play the streamed media (1212), in the case of music converting it to audio (much as the server itself did in the traditional analog multizone audio approach).

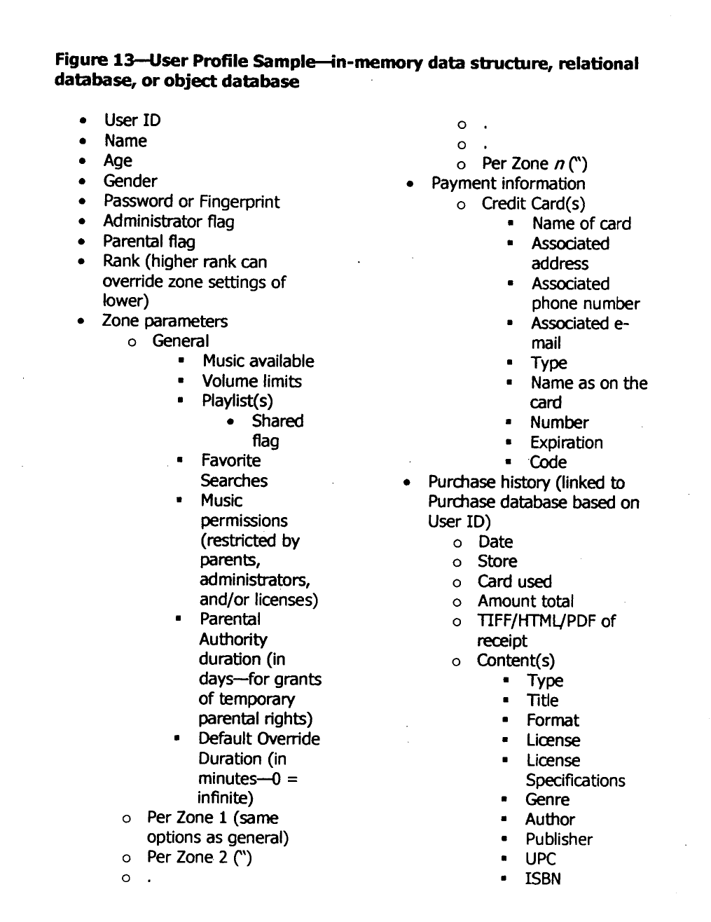

FIG. 13—User Profile Sample—in-Memory Data Structure, Relational Database, or Object Database

User profiles generically are common in computing, perhaps the most common being the user-specific settings associated with each individual computer user ID in any of a variety of multi-user operating systems. But multiple, individualized user profiles are not used in current multizone audio/video systems, making things much easier for designers and developers (since doing this properly is difficult to figure out and implement) but harder for sophisticated and family users (and, more subtly, for rights-owners in a DRM context)—until now.

FIG. 13 depicts this in a sort of outline form—this form is chosen since the invention is indifferent to whether the data are stored in an in-memory data structure, a flat-file database (less efficient, likely), a traditional relational database, or an object-oriented database, or any combination As shown, user profiles are data sets stored preferably on the server (though in principle anywhere is fine, so long as the overall system, typically with a central server storing data, has access to them on demand) that store the preferences, capabilities, and permissions for each individual user, particularly including as desired: user ID and password, credit card information (card type, number, and expiration date; cardholder name, address, phone) for purchasing additional content, records of purchases and installations, license permissions (especially useful for content licenses that are based on user “fingerprints” rather than or in addition to the most common current technology of using system “fingerprints”, and may relate to the records of purchases and installations), parental filtering permissions (permissible/impermissible content for kids), zone control authorities (general and zone-by-zone)), and content playback preferences (e.g., individual-user single- or multi-zone volume and playlist settings).

The individual-user profiles will typically belong to individual users, but they may additionally be shared or virtual, so that parents could share a single profile, e.g., or there could be party, relaxation, or exercise profiles storing preferences (settings and playlists) optimized for those scenarios, or profiles limiting clients meant to control just one zone (e.g., FIG. 1/109)

Some Additional, Secondary Aspects of the Invention

Several additional aspects of the invention warrant serious note:

First, in the examples shown the server is a single, central home computing and storage device with strong network connectivity and optional client capabilities—but this hints at something much stronger still within the scope and spirit of the invention: distributed servers. In principal, there could be multiple servers, each optionally acting as client, all the way to the “extreme” of each client acting as a server. (This is most obviously feasible in the case of multiple desktop PC clients, though other configurations are certainly possible as well, the downside of using portable computers [laptops, notebooks, PDAs] as servers being that their storage capabilities are lost to the rest of the network when they are disconnected from that network.) So long as the music is decoded and outputted on a legitimately licensed computer, and so long as the various servers are sufficiently coordinated that each “knows” the entire and shares its own available content, so that there is still a unified logical server, the invention is indifferent to whether the physical server is centralized or unitary.

Second, the focus for the invention has been very properly and intentionally on a home-based system. But the invention is agnostic on the scope of its underlying network, and in principle could work just as well, e.g., over the Internet as over the home intranet. This theoretical point noted, the focus remains on the home based network for reasons of marketing, simple licensing (applying the invention over the Internet would require safeguards to prevent unauthorized users' access to the content library), and performance in the case of “remote control” installs or playback (the speed of remote control over a LAN is excellent, while over the Internet, potentially iffy, particularly when simultaneous digital content streaming is necessary). Practical beyond-the-home applications of the present invention include office, dormitory, campus, etc. environments.

Third, and related a bit to the preceding point, what if one wishes to purchase content via the invention when away from home or from the Net?

In the former case, it's technically easy to extend the invention from a home-based LAN to the Internet (WAN), particularly for the purchasing or installing of content. (As noted immediately above, playback or other use of the content is trickier, both practically [performance of the WAN versus the LAN for remote control applications or even streaming] and legally [this would need to be done in a way wholly compatible with the license agreement—not just the DRM technology, but the verbal license itself—some of which may prohibit it].)

In the latter case (away from the Internet), it may be simplest just to wait until one does have Internet access; if the customer need is sufficient, however, one could certainly queue and defer the requests (whether they be content inquiries, purchases, or installs) on the relevant (typically notebook or PDA) client until Net or LAN access is available. (This approach could also be taken to time-shift bandwidth consumption even when the Net or LAN is available if the relevant supply of bandwidth is significantly more limited relative to the demand at certain times.)

Fourth, the multiplicity of media content types (not just music, video, and books, but along another axis, a wide variety of DRM types) and sources (from local media, such as CDs, DVDs, USB drives (with previously ripped MP3s, e.g.), etc.) combined with the multiplicity of users (as individuals or groups, each with profiles as desired) within a household allows much more sophisticated marketing analysis. (This is only indirectly a consumer benefit, in that the opportunity to generate superior media content acquisition and usage information will offer another revenue stream leading to future superior products and either to lower prices or higher profitability, all while protecting user privacy and confidentiality.)

For example, in a normal media player environment, one can track which songs or movies are played or purchased—this is easily and commonly done. But the invention allows much greater detail of analysis, not just for one OS user or one computer, but for an entire household aggregated or disaggregated exactly as desired. The particular acquisition, usage, and behavior analyses are not an object of this invention, but the capability to have available the data necessary for such analyses is. Tracking on a per-user-in-household basis things such as purchases, non-online-purchase acquisitions, deletions, content play times (quantity, times of day/week/month/year, distance from time of acquisition, etc.), and then being able to analyze this data in a household demographic context (do children who store the music with the invention and who have two parents purchase less gangsta rap? Do parents who can prevent via user profiles their children from listening to “explicit lyrics” music or watching “adult” videos therefore safely purchase more of them for themselves? How do purchases by and listening habits of older siblings affect younger siblings? and so forth, ad infinitum) is an important advantage over rivals.

Fifth, the ability to store media from a variety of DRM schemes, as well as unprotected media, combined with multiple user or group profiles, suggests additional advantages accruing to more comprehensive libraries, such as superior searching based on the libraries of multiple users, groups, or the household as a whole.

Searching based on recently browsed or purchased items, while quite useful to customer and vendor alike, is nothing new—Amazon and other online stores have done this for years. However, synergistic integration of this search capability with one's own individual, group, and household media libraries raises new and utterly superior possibilities: one can search not only based on what one has browsed or purchased from a given store, but based on the far more complete and informative database of this master media library, including one's own personal favorites within that library, both to find similar items and, perhaps even more interestingly, to discover and fill gaps in one's media library. If one owns all Bob Dylan albums, or all songs on a given album, save one or two, e.g., or is missing only three James Bond movies, this synergized search would not only offer “other people who bought A also bought B” suggestions, but recommendations tailored to many media owners' goal of having complete collections of their favorites: “You are only the HD-DVD version of Serenity away from completing your Firefly collection—click here to purchase for 20% off,” e.g. This searching would be useful not only at the individual, but also the group level, e.g., searching for gaps in an entire family's media collection, the relevant purchases then being encouraged and facilitated.

The gap searching could be implemented by having sets of possible collections (based on the artist, publisher, title, genre or subgenre, date, and/or so forth, or based on editors' choices) and using a somewhat arbitrary quantity- or percentage-based threshold, such that if that threshold is crossed in a user's (or group's) library, recommendations are offered for the remaining items in the collection.

The thresholds used to detect potential collections are somewhat arbitrary—if one owns two Simpsons Seasons, are they the beginning of a collection or nothing more than an ad hoc purchase? It may be useful to let the user specify these thresholds herself for particular known potential collections (already in the collection set), or for potential collections in particular genres (e.g., science fiction, jazz, alternative) or even customized sub-genres (romances with Humphrey Bogart, movies with Nathan Fillion, rap music excluding Snoop Dogg, anime video after 1970, etc.).

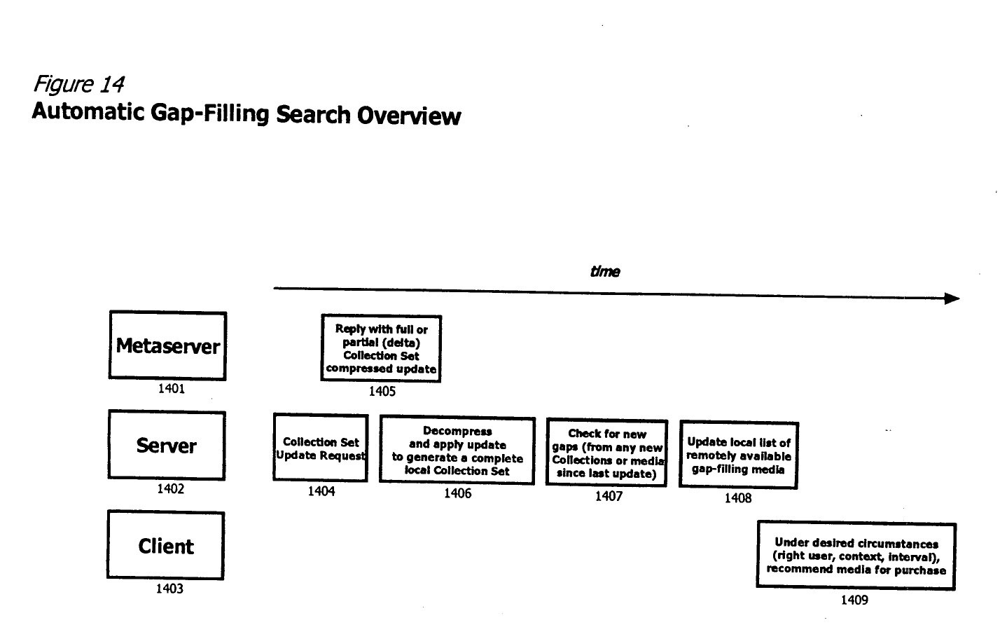

FIG. 14 depicts this more clearly. One new aspect of the “ontology” of the invention is introduced here, though it's not any radical innovation: The Metaserver (1401) is available over the Internet to assist any instance of the invention's home server (1402) by offering updates to program files, documentation, etc., and in this case transfers to any central home server a set of collections, where the relevant meaning of “collection” is defined rather ordinarily as a group of media or media-related (e.g., books, posters, events) items that are considered by people to be closely related.

The central home server (1402), perhaps (but not as shown here) in response to a request from a client (1403), requests (1404) a collection-set update from the BSITS (1401), which then replies (1405) with either a delta file(i.e., a file with the changes since the last update) or the whole latest collection set file itself, as appropriate. (The update would essentially be a database of collections, media item names [or perhaps their hashes, though this would make fuzzy comparisons more difficult], and various properties of the same [genre, artist, date, publisher, and so forth], typically highly compressed simply to save time in the download.) After downloading and installing the update (1406), ensuring that its set of collections is fully up-to-date, the home server checks (1407) for new gaps since the last search (based on new collections in the collection set and new media in the master and each user library) and updates the list of potential collections (1408) based on these newly noted gaps (a potential collection being implied by each gap, and vice versa), Finally, the home server presents (1409), at an appropriate time (e.g., when a relevant user is using the system, when the user's experiencing another already-owned item in the collection, when another purchase is indicated, when sufficient time has lapsed since the last recommendation offer, etc.), recommendations for gap-filling (and perhaps other) purchases.

As an alternative to downloading some sort of master list of potential collections, one could also easily (and more quickly) upload the home server library index to the metaserver for collection checking, but uploading such information would likely raise privacy concerns amongst potential customers, and if the metaserver's update is a delta file and is compressed, download times should be very manageable even on an old-fashioned dial-up connection (especially since it could be done overnight and does not involve the user).

Although only a limited number of embodiments have been described herein, it should be recognized that variations and modifications will seem to those skilled in the art consistent with the teachings herein which are intended to fall within the scope of the appended claims.

1. A client-server content management system that redirects selected client-side installations of content to a central content server.

2. A system of claim 1 which redirects both protected and unprotected content.

3. A system of claim 1 which automatically redirects client-side installation of recognized protected content to a server.

4. A system of claim 1 which automatically redirects client-side installation of recognized unprotected content to a server.

5. A system of claim 1 which redirects from the client to the home content server web sessions involving web sites recognized as offering installable content.

6. A system of claim 1 which permits the user to trigger manually the redirection of client-side installation to a server.

7. A system of claim 1 which redirects local-media-based client-side installation to the server.

8. A system of claim 1 which redirects said installations after-the-fact.

9. A system of claim 7 in which the local medium for installing content is a disk.

10. A system of claim 7 in which the local medium for installing content is flash-memory-based.

11. A system of claim 7 in which the local medium for installing content is accessed via a serial interface.

12. A system of claim 1 which facilitates client usage of a variety of content installed by the system to said content server.

13. A system of claim 12 which facilitates client playback of a variety of content via remote control of said content server.

14. A system of claim 13 which integrates into its own user interface and thereby conceals client remote control of at least one content server based application.

15. A client-server system configured to manage protected digital files, said system comprising:
a source of digital files;
at least one server;
two or more client devices each including input/output means operable by a user for accessing a selected digital file from said source; and
means for redirecting said accessed digital file to said server.

16. The system of claim 15 further including network means; and wherein: said source, said server, and said client devices are coupled to said network for communicating information therebetween.

17. The system of claim 15 wherein said means for redirecting includes means for executing control software.

18. The system of claim 17 wherein said means for redirecting is automatically activated.

19. A method of operating a system comprised of a digital file source, a server, a plurality of client devices, and network means for communicating therebetween said method including the following steps:
operating one of said client devices to access a selected digital file from said digital file source; and
automatically redirecting said accessed digital file to said server for storage.
